(19) United States
(12) Patent Application Publication
(10) Pub. No.: US 2026/0262154 A1
(43) Pub. Date: Sep. 3, 2026

(54) X-RAY GENERATION MODULE

(71) Applicant: DENTIUM CO., LTD., Suwon-si (KR)

(72) Inventors: Bum Ho CHOO, Suwon-si (KR); Dong Wook KIM, Suwon-si (KR); In Hyuk JUNG, Suwon-si (KR); Ji Hwan LIM, Suwon-si (KR); Seong Pil HEO, Suwon-si (KR)

(21) Appl. No.: 19/582,336

(22) PCT Filed: Apr. 19, 2024
(86) PCT No.: PCT/KR2024/005309

§ 371 Date: Apr. 27, 2026

(30) Foreign Application Priority Data
Oct. 27, 2023 (KR) 10-2023-0145902

(51) Int. Cl. H05G 1/06; H01F 27/32; H01J 35/06; H05G 1/10; H05G 1/26

(52) U.S. Cl. CPC H05G 1/06; H01F 27/325; H01F 27/327; H01J 35/064; H05G 1/10; H05G 1/265

(57) ABSTRACT

The present invention provides an X-ray generation module comprising: an X-ray tube provided with a positive electrode having a target, and a negative electrode having filaments; a positive power multiplier for providing multiplied voltage to the positive electrode; a negative power multiplier for providing multiplied voltage to the negative electrode; a high-voltage transformer for providing boosted voltage to the positive and negative power multipliers and arrayed with the positive and negative power multipliers to form a single row; and a filament transformer for providing the filaments with tube current having electrons to be moved toward the target, and insulating the multiplied voltage provided to the negative electrode by the negative power multiplier, the filament transformer being arranged in the single insulated row along with the positive and negative power multipliers and high-voltage transformer.

### TECHNICAL FIELD

The present invention relates to an X-ray generation module used in an X-ray irradiation device.

### BACKGROUND ART

In general, an X-ray irradiation device is widely utilized in a medical field today as a means for acquiring an image of the inside of a human body. The X-ray irradiation devices have been manufactured in a form (standard type) supported on a floor. Recently, portable X-ray irradiation devices have been widely distributed in dental clinics and the like.

For convenient use of portable X-ray irradiation devices, miniaturization (lightweighting) thereof is required. To this end, when various components are miniaturized, withstand voltage characteristics of the respective components are degraded. This makes it difficult for the X-ray irradiation device to operate at high voltage.

Furthermore, in order to insulate the respective components against high voltage, an interior of a box housing the components is sometimes filled with insulating oil. In this case, oil leakage may occur as the insulating oil repeatedly expands and contracts due to heat generated during X-ray generation.

The above-described background art is technical information retained by the inventor to derive the embodiments of the present invention or acquired by the inventor while deriving the present invention, and thus should not be construed as art that was publicly known prior to the filing date of the present invention.

### DISCLOSURE

### Technical Problem

An object of the present invention is to provide an X-ray generation module configured to enable miniaturization while allowing insulation against high voltage to be effectively achieved.

### Technical Solution

According to an aspect of the present invention, an X-ray generation module includes: an X-ray tube including a positive electrode provided with a target, and a negative electrode provided with filaments; a positive power multiplier configured to provide multiplied voltage to the positive electrode; a negative power multiplier configured to provide the multiplied voltage to the negative electrode; a high-voltage transformer configured to provide boosted voltage to the positive and negative power multipliers and arranged along with the positive and negative power multipliers to form a single row; and a filament transformer configured to provide the filaments with tube current having electrons to be moved toward the target, and insulate the multiplied voltage provided to the negative electrode by the negative power multiplier, the filament transformer being arranged in the single row along with the positive and negative power multipliers and the high-voltage transformer.

An extension direction of the single row may be parallel to that of the X-ray tube.

The X-ray generation module may further include a high-voltage board electrically connected to the positive power multiplier, the negative power multiplier, the high-voltage transformer, the filament transformer, and the X-ray tube.

The high-voltage board may have a size that allows a length along the extension direction of the single row to correspond to a length along the extension direction of the X-ray tube.

The high-voltage board may include: a front board disposed such that one side faces the X-ray tube and the other side faces the positive power multiplier, the negative power multiplier, the high-voltage transformer, and the filament transformer; and a rear board disposed on an opposite side of the front board with respect to the positive power multiplier, the negative power multiplier, the high-voltage transformer, and the filament transformer.

The front board may not have a circuit formed thereon.

The X-ray generation module may further include: an inverter configured to provide AC power to the high-voltage transformer and the filament transformer, wherein the rear board may electrically connect the inverter to the high-voltage transformer and the filament transformer.

The high-voltage board may further include a top board connecting the front board and the rear board, and the top board may measure information regarding the X-ray tube and transmit the measured information to the rear board.

The high-voltage board may further include a bottom board connecting the front board and the rear board and disposed to face the top board, and the positive power multiplier, the negative power multiplier, the high-voltage transformer, and the filament transformer may be disposed within a space defined by the front board, the rear board, the top board, and the bottom board.

The filament transformer may include: a primary bobbin on which a primary coil connected to a power supply is wound on its outer surface; and a secondary bobbin on which a secondary coil connected to the filament is wound on its outer surface, and one of the primary bobbin and the secondary bobbin is inserted inside the other of the primary bobbin and the secondary bobbin.

Each of the positive power multiplier and the negative power multiplier may include a first capacitor array and a second capacitor array, and the first capacitor array and the second capacitor array may be arranged along a direction intersecting both the direction from the X-ray tube toward the single row and the extension direction of the single row.

The X-ray generation module may further include a housing box housing the positive power multiplier, the negative power multiplier, the high-voltage transformer, the filament transformer, and the X-ray tube, wherein the internal space of the housing box may be filled with insulating silicone.

### Advantageous Effects

According to the X-ray generation module of the present invention configured as described above, positive and negative power multipliers, a high-voltage transformer, and a filament transformer for applying high voltage and tube current to an X-ray tube are arranged to form a single row, and the filament transformer is configured to have high insulation characteristics of its own. As a result, the X-ray generation module may be miniaturized while having excellent insulation performance against high voltage.

### BRIEF DESCRIPTION OF THE DRAWINGS

FIG. 1 is a perspective view illustrating an X-ray irradiation device XI having an X-ray generation module 100 according to an embodiment of the present invention.

FIG. 2 is a block diagram conceptually illustrating a circuit configuration of the X-ray generation module 100 of FIG. 1.

FIG. 3 is a block diagram conceptually illustrating a structural configuration of the X-ray generation module 100 of FIG. 1.

FIG. 4 is a perspective view illustrating the structural configuration of the X-ray generation module 100 of FIG. 3.

FIG. 5 is an enlarged perspective view of a positive power multiplier 120 of FIG. 4.

FIG. 6 is an exploded perspective view of a filament transformer 150 of FIG. 4.

### BEST MODE

Hereinafter, preferred embodiments of the present invention will be described in detail with reference to the accompanying drawings.

The present invention is not limited to embodiments set forth herein, but may be modified in various different forms. Rather, the present embodiment is provided solely to ensure that the disclosure of the present invention is complete and to fully inform those skilled in the art of the scope of the invention. Accordingly, the present invention should be understood not to be limited to the embodiments disclosed below, but to include all modifications, equivalents, and substitutions that fall within the technical spirit and scope of the present invention, as well as substituting or adding the configuration of any one embodiment with the configuration of another embodiment.

It should be understood that the accompanying drawings are provided only in order to allow embodiments disclosed in the present specification to be easily understood, and the teachings disclosed in the present specification are not limited by the accompanying drawings, but includes all the modifications, equivalents, and substitutions included in the teachings and the scope of the present invention. In the drawings, components may be exaggerated in size or thickness for ease of understanding, but this should not be construed as limiting the scope of protection of the present invention.

Terms used in the present specification are used only in order to describe specific implementation examples or embodiments rather than limiting the present invention. Singular expressions are intended to include plural expressions unless the context clearly indicates otherwise. In the specification, terms such as “comprise” or “include” are intended to specify the presence of stated features, numbers, steps, operations, components, parts, or combinations thereof described in the specification. That is, it should be understood that terms such as “comprise” or “include” in the specification do not preclude the possibility of existence or addition of one or more other features or numbers, steps, operations, components, parts, or combinations thereof.

Terms including ordinal numbers such as “first”, “second”, etc., may be used to describe various components, but the components are not to be construed as being limited to the terms. The terms are used to distinguish one component from another component.

It is to be understood that when one element is referred to as being “connected to/communicate with” or “coupled to” another element, it may be directly connected to/communicate with another element or be coupled to another element, having another element intervening therebetween. On the other hand, it should be understood that when one element is referred to as being “directly connected to/communicate with” or “coupled directly to” another element, it may be connected to or coupled to another element without another element interposed therebetween.

When a component is referred to as being “above” or “below” another component, it should be understood that it is not only disposed directly above that other component, but also that other components may be present in between.

Unless indicated otherwise, it is to be understood that all the terms used in the specification including technical and scientific terms have the same meaning as those that are generally understood by those skilled in the art. Terms generally used and defined by a dictionary should be interpreted as having the same meanings as meanings within a context of the related art and should not be interpreted as having ideal or excessively formal meanings unless being clearly defined otherwise in the present specification.

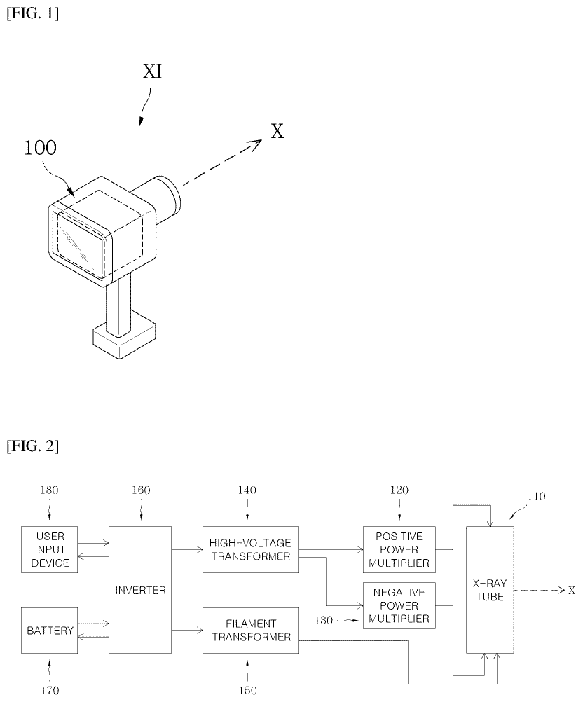

FIG. 1 is a perspective view illustrating an X-ray irradiation device XI having an X-ray generation module 100 according to an embodiment of the present invention.

Referring to the drawing, the X-ray irradiation device XI is miniaturized so that it may be carried by a user. The X-ray irradiation device XI irradiates X-rays X onto an object while being carried by the user. The object may be a human body, an animal, or other industrial/military equipment, etc.

When used on a human body, the X-ray irradiation device (XI) may be used for patients with limited mobility. The X-ray irradiation device XI may also be used to obtain an X-ray image of a part of a patient during surgery.

The X-ray irradiation device XI is equipped with the X-ray generation module 100 that generates the X-rays X. Therefore, in order to miniaturize the X-ray irradiation device XI, the miniaturization of the X-ray generation module 100 should be prioritized.

First, the method for operating the X-ray generation module 100 will be described with reference to FIG. 2. FIG. 2 is a block diagram conceptually illustrating a circuit configuration of the X-ray generation module 100 of FIG. 1.

Referring to the drawing, the X-ray generation module 100 includes an X-ray tube 110. The X-ray tube 110 has a positive electrode and a negative electrode. A target is installed on the positive electrode, and a filament is installed on the negative electrode.

To apply high voltage to the X-ray tube 110, a positive power multiplier 120 and a negative power multiplier 130 are provided. The positive power multiplier 120 is for providing multiplied voltage to the positive electrode, and the negative power multiplier 130 is for providing the multiplied voltage to the negative electrode. The positive power multiplier 120 and the negative power multiplier 130 may produce an output voltage (multiplied voltage) by multiplying input voltage by a Cockcroft-Walton circuit. When the multiplied voltage provided to the positive electrode is 35 kV, the multiplied voltage provided to the negative electrode may be −35 kV.

To apply boosted voltage to the positive power multiplier 120 and the negative power multiplier 130, a high-voltage transformer 140 may be provided. The high-voltage transformer 140 may output the boosted voltage of 4 kV, for example, from an input voltage of 12 V. The high-voltage transformer 140 increases the number of turns of a secondary coil relative to a primary coil to produce the output voltage (boosted voltage) that is significantly boosted compared to the input voltage.

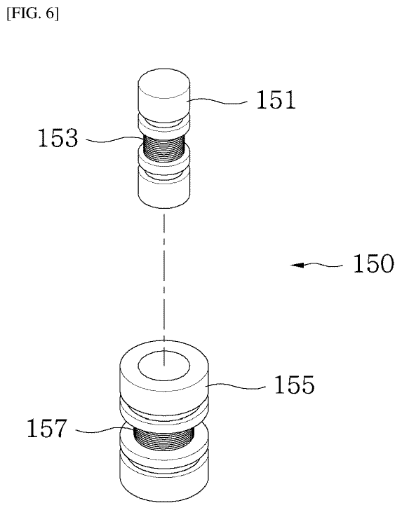

The filament transformer 150 provides tube current to the filament. Electrons included in the tube current are driven to move toward the target by a difference in voltage applied to the positive electrode and the negative electrode. The filament transformer 150 also has the primary coil and the secondary coil, but the number of turns between the primary coil and the secondary coil may be generally the same. The filament transformer 150 is a configuration that has insulation characteristics rather than a configuration for boosting. Since the filament transformer 150 is supplied with a low voltage of 12 V, like the high-voltage transformer 140, and at the same time, is exposed to a high voltage of −35 kV through the negative electrode, excellent insulation characteristics are required due to a large voltage difference. This will be described with reference to FIG. 6.

Referring back to FIG. 2, the power input to the high-voltage transformer 140 and the filament transformer 150 may be provided by an inverter 160. The inverter 160 converts the DC power from the battery 170 into AC power and applies the AC power to the high-voltage transformer 140 and the filament transformer 150.

A user input device 180 is for the user to set operating conditions for the operation of the X-ray irradiation device XI (see FIG. 1). The user input device 180 may be a mechanical switch or a touch button. The user input device 180 may also be a touch display.

According to this configuration, the user may set the tube voltage, the tube current, the irradiation time, etc., through the user input device 180.

When the user presses the user input device 180, specifically the irradiation button, the inverter 160 receives power supply from the battery 170 and outputs voltage, for example, 12V, to the primary coil of the filament transformer 150. The induced voltage, for example, 12V, generated in the secondary coil of the filament transformer 150 heats the filament. The amount of electrons in the filament is related to the tube current of the X-ray tube 110.

In this state, the inverter 160 receives power from the battery 170 and outputs a voltage, for example, 12V, to the primary coil of the high-voltage transformer 140. The induced voltage generated in the secondary coil of the high-voltage transformer 140, for example 4 kV, is applied to the positive power multiplier 120 and the negative power multiplier 130. Each of the positive power multiplier 120 and the negative power multiplier 130 multiplies 4 kV to 35 kV and −35 kV, respectively, and applies the multiplied voltage to the positive electrode or the negative electrode.

35kV and −35 kV are applied to the positive electrode and the negative electrode, respectively, so that the total potential becomes 70 kV, and the electrons generated from the filament strike the target according to the potential (tube voltage) of 70 kV. In this process, the X-rays X are generated and irradiated to the outside. The irradiation time of the X-rays X is the time during which the tube voltage is maintained at 70 kV by driving the high-voltage transformer 140.

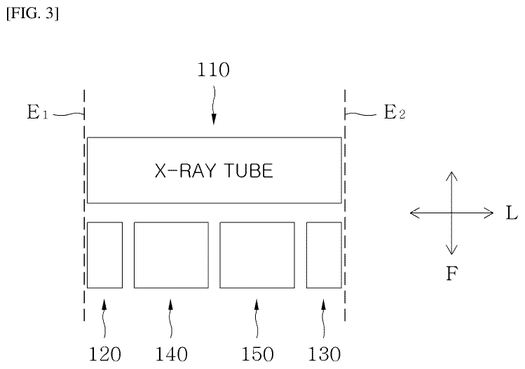

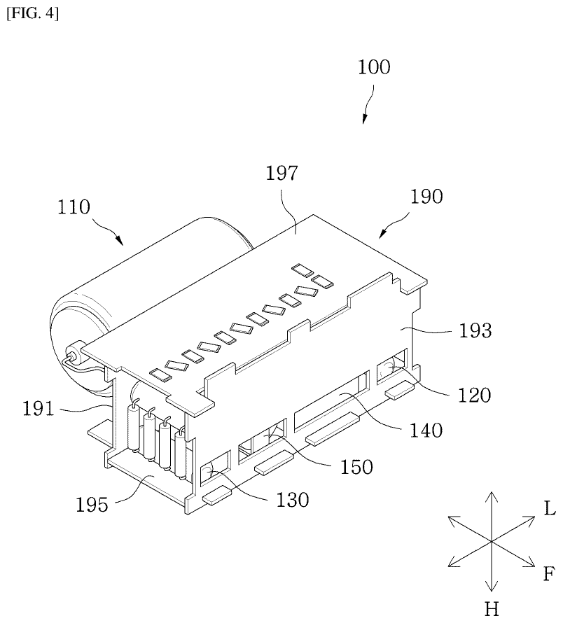

The arrangement relationship of the X-ray tube 110, the positive power multiplier 120, the negative power multiplier 130, the high-voltage transformer 140, and the filament transformer 150 described above is described with reference to FIGS. 3 and 4.

FIG. 3 is a block diagram conceptually illustrating a structural configuration of the X-ray generation module 100 of FIG. 1.

Referring to the drawing, the positive power multiplier 120, the negative power multiplier 130, the high-voltage transformer 140, and the filament transformer 150 may be arranged to form a single row. Specifically, the positive power multiplier 120 and the negative power multiplier 130 may be disposed at edge regions on both sides of the single row corresponding to the positive electrode or the negative electrode. The positive power multiplier 120 may be disposed so as not to cross a boundary line El at one end of the X-ray tube 110, and the negative power multiplier 130 may also be disposed so as not to cross a boundary line E2 at the other end of the X-ray tube 110. In other words, the overall size of the four components 120, 130, 140, and 150 forming the single row may be compacted to a level corresponding to the length of the X-ray tube 110.

Between the positive power multiplier 120 and the negative power multiplier 130, the filament transformer 150 may be disposed closer to the negative electrode than the high-voltage transformer 140. The high-voltage transformer 140 may also be disposed between the positive power multiplier 120 and the negative power multiplier 130, while remaining closer to the positive electrode than the filament transformer 150.

An extension direction of the single row may be parallel to an extension direction L of the X-ray tube 110. Along a front-rear direction F perpendicular to the extension direction L, the single row may be disposed next to the X-ray tube 110.

FIG. 4 is a perspective view illustrating the structural configuration of the X-ray generation module 100 of FIG. 3.

Referring to the drawing, the four components 120, 130, 140, and 150 may be installed on a high-voltage board 190 while forming the single row. The high-voltage board 190 may also electrically connect the four components 120, 130, 140, and 150. The high-voltage board 190 may house the four components 120, 130, 140, and 150. In this case, the high-voltage board 190 may have a size that allows a length along the extension direction L of the single row to correspond to a length along the extension direction L of the X-ray tube 110.

The high-voltage board 190 may have at least one of a front board 191, a rear board 193, a bottom board 195, and a top board 197. The boards 191, 193, 195, and 197 may generally have a flat shape. The longitudinal direction of the boards 191, 193, 195, and 197 may be arranged along the extension direction L.

One surface of the front board 191 is disposed to face the X-ray tube 110, and the other surface is disposed to face the four components 120, 130, 140, and 150. The front board 191 is intended for insulation between the X-ray tube 110 and the four components 120, 130, 140, and 150, and may not have a circuit formed thereon.

The rear board 193 is disposed on an opposite side of the front board 191 with respect to the four components 120, 130, 140, and 150. The rear board 193 may have a circuit that electrically connects the inverter 160 to the high-voltage transformer 140 and the filament transformer 150.

The bottom board 195 may be disposed to connect the front board 191 and the rear board 193. The filament transformer 150 may be mechanically fixed to the bottom board 195. The bottom board 195 may also not have a circuit.

The top board 197 may also be disposed to connect the front board 191 and the rear board 193. The top board 197 is also disposed to face the bottom board 195. The four components 120, 130, 140, and 150 may be disposed within the space defined by the boards 191, 193, 195, and 197. The boards 191, 193, 195, and 197 form a volume that allows the four components 120, 130, 140, and 150 to form the single row.

The top board 197 may also have a circuit for measuring information (tube voltage, temperature, etc.) regarding the X-ray tube 110. The information may be transmitted to the rear board 193 connected to the top board 197. The rear board 193 transmits this information to a board (inverter board, not illustrated) for controlling the inverter 160, thereby enabling the inverter board to provide feedback control of the inverter 160.

The above four components 120, 130, 140, and 150 and the X-ray tube 110 may be housed in a housing box (not illustrated). The internal space of the housing box may be filled with insulating silicone. The insulation between each component may be further strengthened by the silicone. In addition, since there is no use of insulating oil as in the past, the problems caused by oil leakage do not occur.

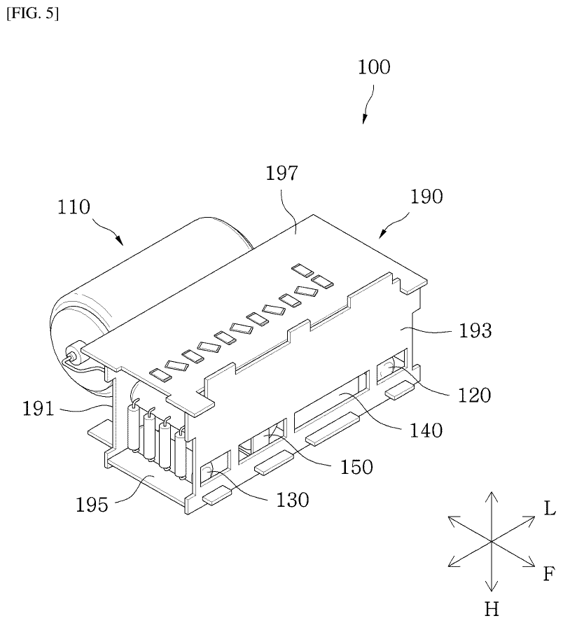

The specific configuration of the positive power multiplier 120 and the filament transformer 150 will be described with reference to FIGS. 5 and 6.

FIG. 5 is an enlarged perspective view of the positive power multiplier 120 of FIG. 4. Although the positive power multiplier 120 is described through the drawing, the same may be applied to the negative power multiplier 130.

Referring to the drawing, the positive power multiplier 120 may include a first capacitor array 121, a second capacitor array 123, and a diode 125.

Inside each of the first capacitor array 121 and the second capacitor array 123, there are multiple independent internal electrode patterns that implement capacitance. The integrated structure of the first capacitor array 121 and the second capacitor array 123 enables the miniaturization of the positive power multiplier 120.

The first capacitor array 121 and the second capacitor array 123 may be arranged in a stacked form along the height direction H. Here, the height direction H is the direction from the bottom board 195 (see FIG. 4) toward the top board 197 (see FIG. 4), and intersects (e.g., vertical) with respect to both the extension direction L and the front-rear direction F.

The diode 125 is disposed to connect the first capacitor array 121 and the second capacitor array 123. The diode 125 may be arranged to extend along the height direction H.

According to this configuration, by configuring the first capacitor array 121 and the second capacitor array 123 in an array-type and also stacking the first capacitor array 121 and the second capacitor array 123 along the height direction H, the space occupied by the positive power multiplier 120 along the extension direction L may be minimized. This allows the four components 120, 130, 140, and 150 to form the single row and have a length corresponding to the length of the X-ray tube 110.

FIG. 6 is an exploded perspective view of the filament transformer 150 of FIG. 4.

Referring to the drawing, the filament transformer 150 has a primary bobbin 151 and a secondary bobbin 155. A primary coil 153 is wound on an outer surface of the primary bobbin 151, and a secondary coil 157 is wound on an outer surface of the secondary bobbin 155.

The secondary bobbin 155 has a hollow portion, and the primary bobbin 151 may be inserted into the hollow portion. According to this structure, a creepage distance between the primary coil 153 and the secondary coil 157 may increase compared to the conventional design.

The increased creepage distance may significantly improve the insulation capability of the filament transformer 150. As a result, the filament transformer 150 may stably protect the inverter 160 even under a large potential difference between the high voltage applied to the negative electrode and the low voltage input from the battery 170.

### INDUSTRIAL APPLICABILITY

The present invention has industrial applicability in the field of manufacturing an X-ray generation module.

1. An X-ray generation module, comprising:
an X-ray tube including a positive electrode provided with a target, and a negative electrode provided with filaments;
a positive power multiplier configured to provide multiplied voltage to the positive electrode;
a negative power multiplier configured to provide the multiplied voltage to the negative electrode;
a high-voltage transformer configured to provide boosted voltage to the positive and negative power multipliers and arranged along with the positive and negative power multipliers to form a single row; and
a filament transformer configured to provide the filaments with tube current having electrons to be moved toward the target, and insulate the multiplied voltage provided to the negative electrode by the negative power multiplier, the filament transformer being arranged in the single row along with the positive and negative power multipliers and the high-voltage transformer.

2. The X-ray generation module of claim 1, wherein an extension direction of the single row is parallel to that of the X-ray tube.

3. The X-ray generation module of claim 1, further comprising:
a high-voltage board electrically connected to the positive power multiplier, the negative power multiplier, the high-voltage transformer, the filament transformer, and the X-ray tube.

4. The X-ray generation module of claim 3, wherein the high-voltage board has a size that allows a length along the extension direction of the single row to correspond to a length along the extension direction of the X-ray tube.

5. The X-ray generation module of claim 3, wherein the high-voltage board includes:
a front board disposed such that one side faces the X-ray tube and the other side faces the positive power multiplier, the negative power multiplier, the high-voltage transformer, and the filament transformer; and
a rear board disposed on an opposite side of the front board with respect to the positive power multiplier, the negative power multiplier, the high-voltage transformer, and the filament transformer.

6. The X-ray generation module of claim 5, wherein the front board does not have a circuit formed thereon.

7. The X-ray generation module of claim 5, further comprising:
an inverter configured to provide AC power to the high-voltage transformer and the filament transformer,
wherein the rear board electrically connects the inverter to the high-voltage transformer and the filament transformer.

8. The X-ray generation module of claim 5, wherein the high-voltage board further includes a top board connecting the front board and the rear board, and
the top board measures information regarding the X-ray tube and transmits the measured information to the rear board.

9. The X-ray generation module of claim 8, wherein the high-voltage board further includes a bottom board connecting the front board and the rear board and disposed to face the top board, and
the positive power multiplier, the negative power multiplier, the high-voltage transformer, and the filament transformer are disposed within a space defined by the front board, the rear board, the top board, and the bottom board.

10. The X-ray generation module of claim 1, wherein the filament transformer includes:
a primary bobbin on which a primary coil connected to a power supply is wound on its outer surface; and
a secondary bobbin on which a secondary coil connected to the filament is wound on its outer surface, and
one of the primary bobbin and the secondary bobbin is inserted inside the other of the primary bobbin and the secondary bobbin.

11. The X-ray generation module of claim 1, wherein each of the positive power multiplier and the negative power multiplier includes a first capacitor array and a second capacitor array, and
the first capacitor array and the second capacitor array are arranged along a direction intersecting both the direction from the X-ray tube toward the single row and the extension direction of the single row.

12. The X-ray generation module of claim 1, further comprising:
a housing box housing the positive power multiplier, the negative power multiplier, the high-voltage transformer, the filament transformer, and the X-ray tube,
wherein the internal space of the housing box is filled with insulating silicone.
